(19) United States
(12) Patent Application Publication
(10) Pub. No.: US 2003/0033245 A1
(43) Pub. Date: Feb. 13, 2003

(54) Method for collection of amounts overdue and due by payday-to-payday drafts

(76) Inventor: Andrew Kahr, San Francisco, CA (US)

Correspondence Address: GLENN PATENT GROUP, 3475 EDISON WAY, SUITE L, MENLO PARK, CA, 94025, US

(21) Appl. No.: 10/111,433

(22) PCT Filed: Apr. 30, 2001
(86) PCT No.: PCT/US01/13975

(51) Int. Cl. G06F 17/60

(52) U.S. Cl. 705/39; 705/36

(57) ABSTRACT

A method and computer program product for collection of amounts overdue and due by payday-to-payday debits from a debtor's asset account. In a first version, using ACII debits, the debtor is solicited by mail and followed-up by telephone. A second version employs payee-emitted checks as a payment vehicle. The debtor authorizes recurring debits equal to one half of a regular monthly payment, on payday dates, from the asset account, beginning on a negotiated date. Subsequently, regular debits from the account are set up. A delinquent account may be re-aged after a required number of drafts have been honored. The invented method allows collections to be made from any customer from asset accounts in virtually any financial institution that is an ACII participant or which pays against checks. The invention also provides the capability of re-submitting rejected debits without expelling the debtor from the payday-to-payday debit program.

### BACKGROUND OF THE INVENTION

### FIELD OF THE INVENTION

The current invention relates to the field of consumer credit and collections. More particularly the invention relates to a method of collecting amounts overdue and due through automated, recurring ACH (Automated Clearing House) debits to or payee-generated checks drafted from a customer's asset account on a payday-to-payday basis.

### DESCRIPTION OF RELATED ART

Prior to the widespread use of the telephone in collections, consumer finance lenders collected delinquent accounts by sending collectors to the customer's residence or workplace in order to secure cash payment. The use of the telephone to contact delinquent accounts notably improved collectors' efficiency, allowing them to contact delinquent payers in far greater numbers. While the use of the telephone considerably reduced the cost of collections, it had the serious drawback of eliminating the possibility of securing immediate cash payment from the debtor. The best the creditor could expect was a promise to pay, which was worth considerably less than cash in hand. Finding out that the promise had not been kept could take several weeks.

In recent years, electronic funds transfer (EFT) technology has made possible the development of paperless systems and methods for collecting funds and meeting financial obligations without using cash or credit cards or other instruments such as checks and money orders. For example, R. Smith, P. Janigan, Automated fund collection system including means to eliminate duplicate entries from a mailing list, U.S. Pat. No. 5,111,395 (May 5, 1992) describe an automated system for raising or collecting funds wherein a contributor or a customer enters into an automatic funds transfer program with a fundraiser or collector. A bank draft, drawn on the collector's bank, is sent to the contributor/customer. In order to cash the draft, the contributor/customer must agree to authorize at least two separate automated fund transfers to the collector's account, each payment equal to half the face value of the bank draft. The contributor/customer may terminate the arrangement after the first two payments, or they may continue. Thus, an ongoing, periodic contribution program may be developed through a single solicitation.

J. Polk, Method and apparatus for payment processing using debit-based electronic funds transfer and disbursement processing using addendum-based electronic data interchange, U.S. Pat. No. 5,946,669 (Aug. 31, 1999) and U.S. Pat. No. 6,119,107 (Sep. 12, 2000) describes a system wherein an initiator authorizes a payment and disbursement to a collector and the collector processes the payment and disbursement through an accumulator agency. An employee makes payment to his or her employer, usually through payroll deduction. The employer transmits an electronic payment to the accumulator agency, which then disburses the payment to a payee or an intermediary. The described system is directed chiefly to court-ordered mandatory obligations such as wage garnishments and child support payments.

Additionally, the prior art provides several electronic bill payment systems. For example, M. Anderson, System and method for paying bills electronically, U.S. Pat. No. 5,283,829 (Feb. 1, 1994) describe a telephone-based electronic bill payment system in which pre-authorized subscribers dial up a payment approval apparatus and enter pre-assigned payment approval numbers, whereupon an electronic funds transfer to the biller's account is initiated. R. Kolling, W. Powar, Electronic bill pay system, U.S. Pat. No. 5,920,847 (Jul. 6, 1999) describe a bill pay system in which participating consumers pay bills to participating billers through a payment network. The consumer transmits payment orders for bills to his or her bank whereupon the bank forwards the order to a payment network, which forwards the order to the biller's bank. The consumer's asset account is debited and the biller's account receives credit, with all transactions mediated through the payment network. J. Hilt, R. Hodges, S. Pardue, W. Powar, Electronic bill pay system, U.S. Pat. No. 6,032,133 (Feb. 29, 2000) describe a similar system.

The systems and methods described above have little to do with collection of delinquent accounts. The teachings of Smith, et al. are directed to solicitation of contributions or sales. The bill paying systems described require direct, voluntary involvement of the consumer's employer or bank, and/or are directed chiefly to the payment of single current bills, rather than recurring payment of sums due periodically on accounts without further action by the customer.

Parallel with ACH, but different from it, systems of payment have also developed in which a consumer telephonically authorizes the payee to generate and deposit a check or draft against the consumer's checking account. These systems generally accommodate only a single payment or a short series of payments. Their purpose is to generate revenue by providing convenience to customers, rather than to prevent credit losses.

The use of electronic funds transfer (EFT) through ACH (Automated Clearing Houses) or payee-generated paper checks has significantly impacted the field of collections. The creditor is now able to obtain “instant money” from the debtor. However, current collection methods consist of trying to get the debtor to pay as much as possible, or as soon as possible. After the debtor agrees to pay, the collector tries to get him to agree to have the amount debited from his checking account by ACH or by the payee's emission and deposit of a check. Collectors usually take orders for individual ACH or payee-emitted check payments, or occasionally for two or three payments, over the telephone. There currently exists no way to enroll the debtor in an automated debit program of indefinitely recurring payments over the telephone. The debtor must give his checking account information to the collector by supplying account information in the form of a voided check. Some billing statements provide a box for a customer to specify that they want future bills paid from the same account that they paid the current bill from. However, such a system requires payment of the entire balance each month, rendering it unsuitable for situations in which payment of a monthly fixed installment or minimum amount is desired, such as with revolving credit accounts or delinquent accounts. Such a system also is not adapted to drafting the payment right after payday, when the probability of funds availability in the consumer's account is greatest.

Typically, ACH or payee emitted check payments solicited by collectors today must bring the account up to date or qualify it for re-aging; and current systems lack the flexibility to provide forbearance for delinquent accounts, in which the debtor is allowed to delay payment further, or make reduced payments on the obligation, without necessarily bringing the obligation fully current or qualifying it for re-aging. Providing such forbearance is beneficial to the lender and the consumer alike. A consumer experiencing financial difficulty is able to satisfy a delinquent financial obligation in manageable increments, while minimizing the negative effect of the delinquent obligation on his credit rating; and the lender reduces the risk that the delinquent account will ultimately have to be written off. Furthermore, re-aging delinquent accounts can be disadvantageous because it deprives the lender of the revenue stream generated by late fees. In addition, immediate forbearance provides the consumer with a rational basis for irrevocably authorizing drafts that continue until full liquidation of the obligation.

While some automated, recurring debit programs currently exist, typically for payment of car loans and mortgages, they are usually set up to receive monthly payments only. The mortgage industry has pioneered the use of payday ACH, in which a loan is accelerated through ongoing payday-to-payday ACH debits made from the homeowner's asset account for the life of the loan. Experience in the mortgage industry has shown that the risk of delinquency among even the highest risk borrowers is greatly reduced through the use of such payday ACH programs. It would be desirable to provide a system, directed specifically to delinquent or potentially delinquent accounts, capable of handling payday-to-payday debits. Furthermore, existing programs usually expel a customer from the program if one, or possibly two drafts are rejected. Subsequent amounts due must be paid in a conventional manner through check or money order. It would be desirable to have the capability to re-submit rejected drafts and continue to collect subsequent amounts through ACH or payee generated check debits.

There exists, therefore, a need in the art for a method of collecting amounts overdue and subsequently due on consumer credit obligations through recurring, automated ACH debits or payee generated checks against a debtor's checking or other asset account. It would be advantageous to obtain and implement an initial deferred promise of regular payments over the telephone, without the requirement of written authorization from the debtor. It would be desirable to make the debits from the debtor's asset account on a twice monthly or semimonthly basis, preferably on, or close to, the day that the debtor's paycheck is deposited to the same account. It would also be an advantage to provide the flexibility to either re-age the account or allow the account to remain one payment delinquent so that future late fee revenue is conserved. Furthermore, it would be a great advantage to provide forbearance, to resubmit rejected drafts and to retain a debtor in an automated program after a draft has been rejected, all in order to minimize the probability that a delinquent account will ultimately have to be charged off. Moreover, it would be desirable to be able to debit asset accounts in any type of financial institution. It would also be extremely desirable that the debtor's authorization for the recurring drafts be irrevocable once given, that it be obtainable by telephone without prior written communication, and that it be applicable not only to one specified asset account of the consumer but to any others which the payee may subsequently locate.

### SUMMARY OF THE INVENTION

The invention provides a method for collection of amounts overdue and subsequently due by payday-to-payday drafts from a customer's asset account. A first version of the invention uses ACH debits to the customer's asset account. Initially, the customer is solicited through a mailing containing a pass code. After the mailing, the customer can be enrolled by telephone. If unable to pay the entire amount due, the customer authorizes recurring ACH debits equal to one half of a regular monthly payment or a monthly minimum payment, on payday dates, from the account from which the last payment on the obligation was made, to begin at a negotiated date. Subsequently, regular ACH debits from the account are set up, beginning on the negotiated date.

A second version of the invention uses payee-emitted checks to debit the customer's checking account. In this case, the mailing and pass code are unnecessary. Subsequently, regular, payee-emitted check debits from the account are set up, beginning on the negotiated date.

In either version of the invention, debits may be of a constant amount or of variable amounts. The delinquent account can be re-aged after a required number of drafts have been honored. If desired by the creditor, the account may be re-aged to one payment cycle delinquent in order to conserve late fee revenue. The invented method allows collections to be made from any customer from asset accounts in virtually any financial institution that is an ACH participant or which pays against checks. The invention also provides the capability of re-submitting rejected debits without expelling the customer from the payday-to-payday debit program. In the case of payee emitted checks, the consumer's authorization for recurring debits that continue until complete liquidation of the debt can be irrevocable and applicable to any of his asset accounts that may be subsequently located by the payee, and can provide for collection of the entire amount due in one debit.

### BRIEF DESCRIPTION OF THE DRAWINGS

FIG. 1 provides a flowchart of a method for collection of amounts overdue and due by payday-to-payday debit according to the invention.

### DETAILED DESCRIPTION

Seriously and recurrently delinquent accounts have been a source of great frustration to professionals within the consumer credit and collection industry. Generally, getting a deeply delinquent customer to agree to resume regular payments on an account and to consistently honor the agreement has been regarded as nearly impossible. A slightly delinquent account can slip into irrecoverably deep delinquency. A previously delinquent account that has improved or paid current can again miss payments. In answer to these well-recognized problems, the invention provides a method and a corresponding computer program product for collecting amounts overdue and due on delinquent or previously delinquent accounts through the use of automated, recurring debits to the customer's asset account, either through ACH (Automated Clearing House) in a first version of the invention, or payee- emitted check in a second version of the invention, at payday-to-payday intervals, generally twice per month; so that the combined debits for one billing cycle, generally one month, equal a single payment. Thus the debits are more affordable to the customer, and the possibility of dishonored debits is greatly reduced. The payee gets first access to the consumer's income flow, on every payday. In this system, the first debit can be delayed to a negotiated date, possibly a quite distant one, at which time the delinquent customer believes that his financial situation will have improved, so that the regular payments will not impose an undue hardship. In this way, the chances of obtaining initial and ongoing compliance from the customer are greatly improved. Hence, the possibility that the account will ultimately have to be charged off by the lender is significantly reduced. Subsequently, when the account is current, the debits are continued to insure that the customer doesn't fall back into delinquency. The invented method allows the lender to obtain “first dollar” from the borrower's income in satisfaction of the debt, even when the debt is no longer delinquent. What's more, further delinquency and collection costs are greatly reduced; and frictional contacts with customers, which harm relationships and generate complaints and legal exposure, are kept to a minimum.

In overview, the invented method collects periodic payments on delinquent or risky consumer credit accounts, wherein the payments are automatically debited to the customer's asset account through a series of recurring funds transfers, which are either ACH debits or payee-emitted checks, on a payday-to-payday basis. In general, the invented method includes the steps of:

If ACH is to be used, delivering a pass code and terms of payment to the delinquent customer; usually in the form of a mailed statement;

Obtaining from the customer a promise of regular, payday-to-payday-payments against the delinquent account, usually during a follow-up telephone call;

Negotiating a payment amount and a debit schedule for these debits; and

Implementing and continuing the funds transfers until the account is fully liquidated.

In an essentially paperless ACH transaction described above, the customer assents to the terms of payment, the payment amount, and the payment schedule and authorizes the implementation of debits by reading back the pass code to the collector.

If payee-emitted checks are to be the payment vehicle, no pass code is needed. Thus, the method according to the second version of the invention generally includes the steps of:

Obtaining from the customer a promise of regular, payday-to-payday-payments against the delinquent account, usually during a telephone call;

Negotiating a payment amount and a debit schedule for these debits; and

Implementing and continuing the funds transfers until the account is fully liquidated, in which the funds transfers are made by means of payee-emitted checks that are then deposited to the payee's asset account, and presented to the customer's financial institution for payment.

ACH DEBITS

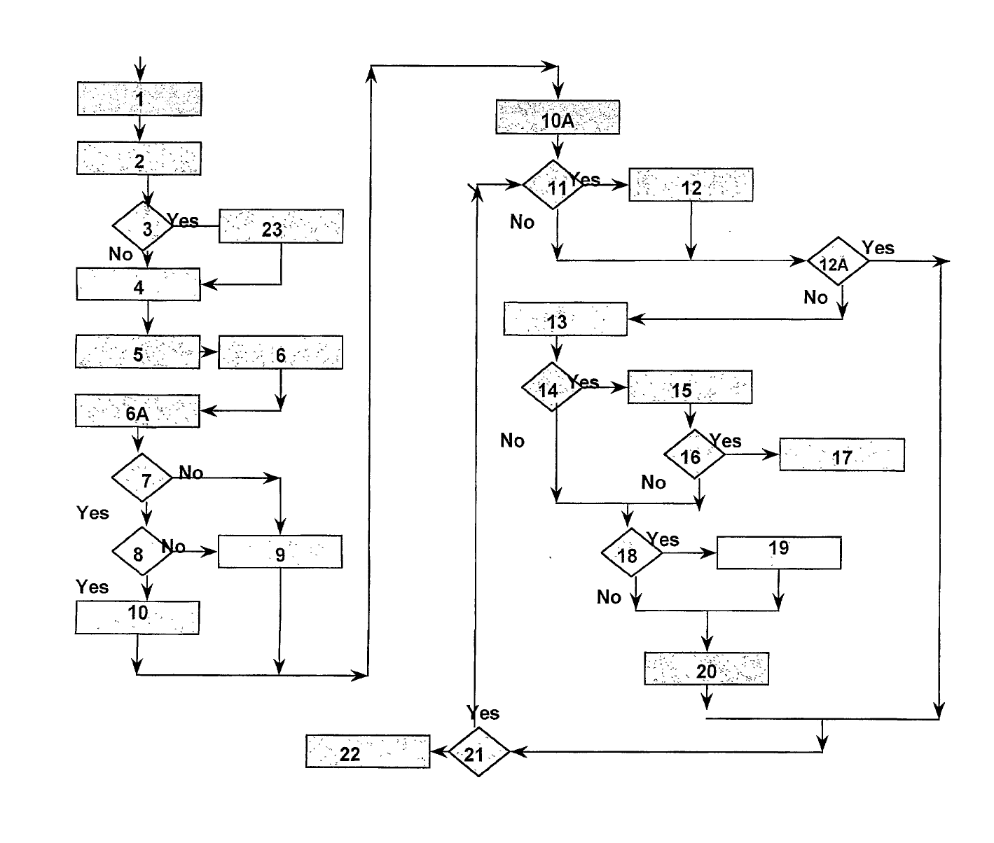

FIG. 1 provides a flowchart of a first version of the invention. According to this version of the invention, in which ACH is used as the payment vehicle, the customer is first mailed a letter or billing statement 1 that includes a pass code, an invitation to participate in the payday-to-payday debit program and an authorization. Inducements to participate, such as an offer of forbearance or more favorable debit terms, may be offered.

Following delivery of the introductory letter or billing statement, the collector and the customer communicate by telephone 2. Broadcast dialing may be used to encourage incoming calls. In the event that the collector has called the customer, the customer may be asked to call back immediately so that the ACH enrollment can be made on an incoming call.

It should be noted that, although the term “collector” will be used here for the individual who communicates with the customer on behalf of the payee, this individual might, in fact, be a customer service or sales-oriented employee, particularly if the customer is only slightly delinquent or is not delinquent. The customer might be a former delinquent, or a non-delinquent who is deemed to be at relatively high risk of delinquency. Also, as described below, the role of “collector” might be filled instead by a VRU (voice response unit), under computer control.

At the time of the call, if the customer is delinquent, the collector asks if the customer is able and willing to pay the total amount due on the account immediately 3. If the customer is unwilling or unable to pay this amount immediately, the collector asks if he can pay a smaller amount. If the customer is willing to pay any amount immediately, the collector seeks an authorization for and, if obtained, implements an ACH debit for the negotiated amount 23. Whether or not the customer is delinquent and whether or not an immediate debit is to be made, the collector proceeds to attempt to enroll the customer in the ACH program. It should be appreciated that, while bringing the account current by paying off any delinquency is a desirable outcome, the most important of the desired outcomes of this call is to enroll the customer in the recurring debit program. There is no way of being certain that the customer will honor any promise to pay the entire delinquent amount or other amounts which will become due unless he is immediately enrolled in the program. If he does not enroll or pay, further collection attempts must be made, involving additional time and expense, and risk of default and loss. Even if the customer does pay for a while, there is still a very good chance that he will fall into delinquency again. The program of recurring payday ACH debits herein provided greatly minimizes the possibility that even a high-risk customer will fall into delinquency in the future. Moreover, the invented method is designed to generate additional fee revenue for the creditor or the program vendor, as described below. Thus, the primary object of the phone call is to set the customer up on a program of recurring payday ACH debits.

The collector describes the program to the customer and may offer various inducements for the customer to enroll. For example, the creditor may be willing to wait longer for payment, or may be willing to accept smaller payments. In the case of serious delinquents or charged off accounts, an offer to reduce the amount owed may be made. Additionally, fees, such as late fees, may be waived. Moreover, the creditor may offer to re-open the account or increase the credit line when a predetermined number of debits have gone through satisfactorily. The loan terms may be made more favorable to the customer, perhaps contingent on satisfactory collection of debits. In the case of an open-end account, the credit line may be increased in return for the customer's enrollment in the program.

The collector negotiates a payment amount and a debit schedule. First, the collector ascertains the frequency of the customer's paydays, simply by asking how often he or she is paid 4. In addition, the collector ascertains when the customer's next payday is. The current description assumes that the customer is paid bi-weekly. However, this description is merely exemplary. In actual fact, the invention is applicable to payday-to-payday intervals of any length; for example semi-monthly, weekly, or monthly. In the case of a bi-weekly pay period, in months having three paydays, debits may be made only for two of the three paydays, if desired. If three debits are made, payment of the debt is accelerated, resulting also in an interest saving which may serve as additional inducements for enrollment. In the presently preferred embodiment of the invention, a basic debit amount is negotiated 5 equal to one half of the required monthly payment on the account. However, the basic debit amount may also fluctuate in a variety of ways. In the case of a revolving account, the basic debit amount may be one half of the monthly minimum payment; thus as the account balance decreases, the basic debit amount also decreases. For a revolving account, the basic amount may alternatively be calculated from the minimum payment that would be due if balance equaled credit line. As previously described, a lower basic debit amount may be offered for the first few debits as an incentive. For a period of time, the customer may be allowed to make interest only payments. Furthermore, in order to avoid re-aging the account, a higher basic debit amount may be required initially, in order to bring the account current within a reasonable period of time. The basic debit amount may also change over time to include fees or other charges added to the account.

After a basic debit amount is established, a first debit date is set 6. The collector asks the customer if he can pay from his next paycheck; if not, then he asks about the payday after that, and so on. Since the prime object is not to clear up the delinquency as quickly as possible, but rather to enroll the customer in the ACH program, it is preferable to be reasonably flexible on the start date. Thus, the negotiated start date may be rather distant. When all terms have been agreed upon, the customer indicates his agreement with the terms and authorizes the debits by reading back the provided pass code 6a.

ACH transactions are governed by regulations of the Federal Reserve Board and the National Automated Clearing House Association (NACHA). Under such governing regulations, a consumer may authorize up to several ACH debits from an asset account over the telephone without any written or printed authorization or documentation However, the ACH governing regulations require that in authorizing a regularly recurring debit over the telephone, as herein described, the customer must read back a previously provided pass code to the collector, and this must be done in a phone call originated by the payor. Additionally, in the case of ACH, an authorization must be provided to the customer with the pass code. In general, the authorization includes a listing of the terms of payment, not including a payment amount or a date. Thus, delivering the pass code and the authorization in a regular billing statement or introductory letter readily satisfies ACH regulatory requirements. The pass code need only be an alphanumeric string. In the ACH version of the invention, a modification of the credit account number is employed as pass code. However, the customer's Social Security number, or a random combination of characters may be equally suitable. In the preferred embodiment of the invention, a telephonic communication is used to enroll the customer in the ACH program and secure the authorization for the debits. However, e-mail, voicemail, the spoken word, and any other paperless mode of communication would also be suitable. Telephonic communication, however affords an opportunity for more direct and efficient interaction with the customer.

In order to maximize efficiency and reduce costs, the method of contacting customers may be at least partially automated. A computer-controlled dialer initiates broadcast calls. When contact has been made with the customer, the call may be connected with a voice response unit (VRU) or a live collector. Generally, the nature of the communication is sufficiently stereotypical to be handled completely through the VRU. However, deep delinquencies or cases involving multiple decisions or judgments may be redirected to a live collector.

The customer's authorization to initiate the debits having been obtained, it is determined whether debits can be made from the asset account from which the last payment to the customers account was made 7. It is preferable to debit from the prior account. However, the prior account may have been closed, or may be otherwise unsuitable or inaccessible. If it is necessary to debit from another account, the collector obtains the account number and routing and transit number of the customer's bank from the customer 9. If the prior account may be used, it is determined if the account can be identified from prior payment data 8. If so, the account number and routing number are retrieved from the prior payment data 10. If the prior account number and routing number are unavailable, the collector must obtain them from the customer 9. Retrieving the account number and the routing number from prior payment data offers several important advantages. Eliminating the need to obtain account information from the customer circumvents any residual resistance the customer may have to enrolling in the debit program. Additionally, it streamlines the communication and minimizes the amount of information that need be extracted from the customer. Furthermore, the possibility of the customer providing inaccurate account information is eliminated. Still further, it provides a great time saving over the conventional method of obtaining account information by having the customer read the number from a blank check. Finally, interaction with the customer is concluded by sending a confirmation letter as to the debit amounts and the debit schedule 10a.

When the customer's authorization has been obtained, the debits are implemented by executing the initial debit on the agreed date and executing subsequent debits according to the agreed schedule. Typically, the customer is charged a fee for each debit, which is added to the basic debit amount before the debit is executed. However, as described above, the debit fees may have been reduced or waived. Thus, it must be determined whether a debit fee is to be added to the basic debit amount prior to executing the debit 11. If so, the fee is added to the basic debit amount 12. The fee is not posted to the credit account, only the basic debit amount. In the preferred embodiment of the invention, debits are executed twice or three times per month in the case of biweekly paydays, on or shortly after the date on which the customer's paycheck is to be credited to his bank account. Customers who are paid bi-weekly will have months with three paydays. If it is desired to avoid executing more than two debits per month, it is necessary to determine whether two debits have already been made in the current month. If so, then an undesired third debit is not executed.

After a debit is executed, it may be dishonored 14, perhaps because the account is overdrawn or the customer has closed the account without informing the creditor or the program vendor, or because of a stop payment order by the customer. While such occurrences may be minimized by contractually obligating the customer to inform the creditor or the program vendor of account changes, they may still occur occasionally. Conventionally, debit programs have lacked the capability of resubmitting a dishonored debit. In the event of one or two dishonored debits, they tend to expel the program participant and require him to pay by other means, thus inviting further delinquency. Since the prime object of the invention is to retain the customer in the program, thus avoiding further delinquency and increased risk of charge off, in this invention, a dishonored debit is re-entered after a predetermined interval 15. Only after being dishonored a second time 16 is the customer contacted 17. The object of contacting the customer is to motivate compliance with the debit program and, if needed, to obtain updated payment and/or account information. As long as the customer continues participating in the program, the risk of further delinquency and eventual charge-off of the delinquent account is minimized. Furthermore, rejected debits provide the creditor or the program vendor with an additional opportunity for fee revenue. In the preferred embodiment of the invention, the customer is charged a fee for each rejected debit that is approximately equal to the late fee for the account, whether or not rejection results from a stop payment order. In addition, a late fee is assessed as provided in account terms. Once the account is again current, the customer is promised that no further late fees will be charged as long as no further debits are dishonored. Dishonored drafts will be resubmitted and new drafts will be originated until the account has been liquidated.

If the debit is honored, it is determined whether the account is to be re-aged. 18. Advantageously, the invention has the optional capability of re-aging an account to a current status, or re-aging the account so that it remains delinquent by one payment cycle. The creditor may find it desirable to keep the account one cycle delinquent in order to maximize late fee revenue, while still reducing the amount owed on the account. The account is re-aged by the appropriate amount 19 and the account credited for the basic amount of the debit 20. After the account is credited, the account balance is evaluated 21. If a balance remains, another debit is executed according to schedule. If not, the debits are terminated 22. It should be noted that only the basic debit amount is posted to the credit account; any fees added to the basic debit amount that result from the program itself, such as the debit fee or late fees, are not.

While the previously described embodiment makes it possible to enter debits only twice per month in the case of customers who are paid bi-weekly, it is also possible to collect these twice yearly “extra payments,” and deduct all fees from the extra payments, instead of adding fees onto the basic debit amount. This may reduce the customer's concern about such fees. It can also result in acceleration of loan payments and reduction in total interest paid by the customer. These benefits can be effective in motivating customers to enroll and can increase customer satisfaction.

The terms of the program allow the customer limited flexibility to change the debit account subject to terms, with provision of proper notice to the creditor or the program vendor. The terms also include a requirement that the customer remain in the program for the life of the account. Such provisions further minimize the possibility of later delinquency and eventual charge-off and enhance opportunities for fee revenue. In one preferred embodiment of the invention, the customer is provided the debit service free of charge for an initial period, for example thirty to ninety days. If they are willing and able, customers may pay off their accounts during this initial period, and if they do so they are freed of the necessity of paying for the debits that have been made. If the customer continues after the introductory period, appropriate fees are charged, possibly against third or “extra” monthly debits, as described above, which can include fees for debits made during the introductory period.

After the introductory period, the customer may wish to make additional payments on the account principal. The program software may include the capability of accepting additional payments on the principal in odd amounts. However, the creditor may wish to discourage prepayment of the account by imposing a fee for prepayment of the account; or for payments other than payments made through the regular debits. Such payments may be prohibited, or they may be applied to a security (savings) account after the initial period.

The effectiveness of the debit program may be enhanced by careful selection of candidates for the program. Checking account information is available from a variety of vendors. Using such information, customers who regularly overdraw their checking accounts may be screened from consideration for the program.

PAYEE-EMITTED CHECKS

As previously noted, a second version of the invention is provided in which the payment vehicle is a paper check, generated by the payee, After enrolling the customer in the debit program, in a manner similar to that previously described, the creditor generates a paper check for each debit to be made to the customer's asset account. On the negotiated dates, the checks are deposited to the creditor's account and subsequently presented to the customer's financial institution for payment. The method employing paper checks is analogous to the ACH method in almost every respect, with a few exceptions described below.

While the ACH method provides the important advantage of paperless transactions, the use of payee-emitted checks as the payment vehicle provides several distinct advantages of its own. Laws and regulations applicable to ACH require that the customer be permitted to discontinue ACH debits upon brief notice, although they do not prohibit imposition of fees or adverse changes in loan terms should this event occur. These authorities also limit ACH authorizations to a single, specified asset account. None of these restrictions apply to payee-emitted check debit programs. Accordingly, the customer's authorization for the latter type of program can and should be irrevocable and should extend to any of his current or future asset accounts. The check-based program may be used to make a debit for the entire amount due which, in the case of an account that has been defaulted or accelerated, may be the entire account balance.

Banking regulations do not require the use of a pass code for check-based debit programs. Thus, the initial mailing, providing the customer with a pass code, required in the ACH program, may be dispensed with in the check-based program. Obviously, it is also unnecessary to have the customer read back a pass code over the telephone to the person securing the customer's authorization to implement the debits. A customer may be enrolled in the check-based program directly upon his assent being given during a phone call originated either by the debtor or the creditor.

The step of executing the debits differs from that of the ACH program in that the ACH debit is essentially an electronic funds transfer, consisting of a single transaction. The check-based program requires at least the following alternate steps:

generating the check by the payee;

depositing the check to the payee's asset account;

presenting the check to the customer's financial institution by the payee's financial institution for payment.

As previously discussed, the terms of the program allow the customer to change the debit account subject to appropriate limitations, with provision of proper notice to the creditor or the program vendor. The terms of participation in the check-based program also include a requirement that the customer remain in the program for the life of the account, and also include permission for the payee to charge debits to other current or future asset accounts belonging to the customer.

The invention is implemented using conventional techniques well known to those skilled in the art of software engineering and computer programming. As previously indicated, the invention is embodied both as a method and a computer program product for performing the invented method. The invented computer program product comprises computer readable program code for performing the invented method wherein the computer readable program code is embodied in a computer-usable storage medium. The storage medium may be a removable medium, such as a compact disk or one or more floppy disks, or it may be a fixed mass storage device, such as a disk drive.

Although the invention has been described herein with reference to certain preferred embodiments, one skilled in the art will readily appreciate that other applications may be substituted without departing from the spirit and scope of the present invention. Accordingly, the invention should only be limited by the Claims included below.

1. A method of collecting periodic payments on a consumer financial obligation, wherein payments are automatically debited to a customer's asset account through a series of recurring electronic funds transfers on a payday-to-payday basis, said method comprising the steps of:
delivering a pass code and terms of payment to said customer;
obtaining a promise from said customer of regular, payday-to-payday payments against said financial obligation in the course of one or more of an oral, an electronic and a telephonic communication;
negotiating a payment amount and debit schedule for said payments; and
implementing said series of funds transfers;
wherein said customer assents to said terms of payment, said payment amount, said payment schedule and authorizes said implementation by providing said pass code during said communication.

2. The method of claim 1, wherein said communication is at least partially automated.

3. The method of claim 1, wherein said consumer financial obligation comprises a delinquent account, wherein said payments are for amounts overdue and subsequently due on said delinquent account and wherein said customer comprises a delinquent debtor.

4. The method of claim 3, wherein said electronic funds transfers comprise Automated Clearing House (ACH) debits to said debtor's asset account.

5. The method of claim 4, wherein said asset account comprises one of a checking account, a savings account, and a money fund account, wherein said asset account resides with an ACH participating financial institution.

6. The method of claim 3, wherein said payday-to-payday payments are any of monthly, approximately bi-weekly and weekly.

7. The method of claim 3, wherein said step of providing said pass code and said terms of payment comprises:
mailing said debtor a billing statement, wherein said billing statement contains said pass code and an authorization, said authorization including at least a partial listing of said terms of payment.

8. The method of claim 3, wherein said step of negotiating a payment amount and a debit schedule comprises the steps of:
establishing contact with said debtor by telephone; and
attempting to secure payment of the entire amount due.

9. The method of claim 8, wherein said step of negotiating a payment amount and a debit schedule further comprises the steps of:
if said debtor is unable to pay the entire amount overdue:
determining how often said debtor is paid and dates of approaching paydays;
determining a basic debit amount;
establishing a first debit date and debit schedule;
obtaining debtor's authorization to debit and said pass code.

10. The method of claim 9, wherein said basic debit amount is approximately equal to half of one of a monthly payment and a monthly minimum payment if said payday is approximately bi-weekly.

11. The method of claim 9, wherein said basic debit amount is variable.

12. The method of claim 11, wherein said basic debit amount decreases as said account balance decreases.

13. The method of claim 9, further comprising the step of:
confirming said debit amount and said debit schedule with said debtor by letter.

14. The method of claim 9, wherein said step of implementing said series of electronic funds transfers comprises the steps of:
obtaining debit account information;
optionally, adding a fee to said basic debit amount; and
executing debits according to said terms of payment, negotiated payment amount and debit schedule.

15. The method of claim 14, wherein said step of obtaining debit account information comprises one of the steps of:
retrieving and confirming an account number and a routing number for an asset account from which a payment to said delinquent account was most recently made; and
obtaining an account number and a routing number from said debtor for an asset account to be debited.

16. The method of claim 14, further comprising the step of:
when a debit has been dishonored a first or subsequent time, re-entering said debit after a pre-determined interval.

17. The method of claim 14, further comprising the step of:
when a debit has been dishonored one or more times, contacting said debtor.

18. The method of claim 14, further comprising the step of:
crediting said delinquent account.

19. The method of claim 3, further comprising the step of re-aging said delinquent account.

20. The method of claim 19, wherein said step of re-aging said delinquent account comprises one of the steps of:
bringing said delinquent account current; and
keeping said delinquent account delinquent by at least one payment cycle.

21. The method of claim 19, further comprising the step of:
where said delinquent account is a revolving account, after re-aging, reopening said account if it has been closed.

22. A computer program product for collecting periodic payments on a consumer financial obligation, wherein payments are automatically debited to a customer's asset account through a series of recurring electronic funds transfers on a payday-to-payday basis, said computer program product comprising a computer usable storage medium having computer readable computer code means embodied in the medium, the computer code means comprising computer readable program code means for:
delivering a pass code and terms of payment to said customer;
obtaining an initial, deferred promise of regular, payday-to-payday payments against said financial obligation in the course of one or more of an oral, an electronic, and a telephonic communication;
negotiating a payment amount and debit schedule for said payments; and
implementing said series of funds transfers;
wherein said consumer assents to said terms of payment, said payment amount, said payment schedule and authorized said implementation by providing said pass code during said communication.

23. The computer program product of claim 22, wherein said communication is at least partially automated.

24. The computer program product of claim 22, wherein said consumer financial obligation comprises a delinquent account, wherein said payments are for amounts overdue and subsequently due on said delinquent account, and wherein said customer comprises a delinquent debtor.

25. The computer program product of claim 24, wherein said electronic funds transfers comprise Automated Clearing House (ACH) debits to said debtor's asset account.

26. The computer program product of claim 25, wherein said asset account comprises one of a checking account, a savings, and a money fund account, wherein said asset account resides with an ACH participating financial institution.

27. The computer program product of claim 24, wherein said payday-to-payday payments are any of monthly, bi-weekly, semi-monthly, and weekly.

28. The computer program product of claim 24, wherein said computer readable program code means for providing said pass code and said terms of payment comprises computer readable program code means for:
mailing said debtor a billing statement, wherein said billing statement contains said pass code and an authorization, said authorization including at least a partial listing of said terms of payment.

29. The computer program product of claim 24, wherein said computer readable program code means for negotiating a payment amount and a debit schedule comprises computer readable program code means for:
establishing contact with said debtor by telephone, and
attempting to secure payment of the entire amount due.

30. The computer program product of claim 24, wherein said computer readable program code means for negotiating a payment amount and a debit schedule further comprises computer readable program code means for:
if said debtor is unable to pay the full amount now due:
determining how often said debtor is paid and dates of approaching paydays;
determining a basic debit amount;
establishing a first debit date and debit schedule; and
obtaining debtor's authorization to debit and said pass code.

31. The computer program product of claim 30, wherein said basic debit amount is approximately equal to half of one of a monthly payment and a monthly minimum payment.

32. The computer program product of claim 30, wherein said basic debit amount is variable.

33. The computer program product of claim 32, wherein said basic debit amount decreases as said account balance decreases.

34. The computer program product of claim 30, wherein said computer readable code means further comprises:
computer readable program code means for confirming said debit amount and said debit schedule with said debtor by letter.

35. The computer program product of claim 29, wherein said computer readable program code means for implementing said series of electronic funds transfers comprises computer readable program code means for:
obtaining debit account information;
optionally, adding a fee to said basic debit amount; and
executing debits according to said terms of payment, negotiated payment amount and debit schedule.

36. The computer program product of claim 35, wherein said computer readable program code means for obtaining debit account information comprises computer readable program code means for one of:
retrieving and confirming an account number and a routing number for an asset account from which a payment to said overdue account was most recently made; and
obtaining an account number and a routing number from said debtor for an asset account to be debited.

37. The computer program product of claim 35, further comprising computer readable program code means for:
when a debit has been dishonored a first or subsequent time, re-entering said debit after a predetermined interval.

38. The computer program product of claim 35, further comprising computer readable program code means for:
when a debit has been dishonored one or more times, contacting said debtor.

39. The computer program product of claim 35, further comprising computer readable program code means for crediting said account.

40. The computer program product of claim 24, further comprising computer readable program code means for re-aging said account.

41. The computer program product of claim 40, wherein said computer readable program code means for re-aging said account comprises computer readable program code means for one of:
bringing said account current; and
keeping said account delinquent by at least one payment cycle.

42. The computer program product of claim 40, further comprising computer readable program code means for:
where said account is a revolving account, after re-aging, re-opening said account if it has been closed.

43. A method of collecting periodic payments on a consumer financial obligation, wherein payments are automatically debited to a customer's asset account through a series of payee-emitted checks on a payday-to-payday basis, said method comprising the steps of:
obtaining a promise from said customer of regular, payday-to-payday payments against said financial obligation in the course of one or more of an oral, an electronic and a telephonic communication;
negotiating a payment amount and debit schedule for said payments; and
implementing said series of funds transfers;
wherein said customer assents to said terms of payment, said payment amount, said payment schedule and authorizes said implementation.

44. The method of claim 43, wherein said communication is at least partially automated.

45. The method of claim 43, wherein said consumer financial obligation comprises a delinquent account, wherein said payments are for amounts overdue and subsequently due on said delinquent account and wherein said customer comprises a delinquent debtor.

46. The method of claim 43, wherein said asset account comprises any type of account against which payee-emitted checks may be drawn.

47. The method of claim 45, wherein said payday-to-payday payments are any of monthly, bi-weekly, semi-monthly and weekly.

48. The method of claim 45, wherein said step of negotiating a payment amount and a debit schedule comprises the steps of:
establishing contact with said debtor by telephone; and
attempting to secure payment of the entire amount due.

49. The method of claim 48, wherein said step of negotiating a payment amount and a debit schedule further comprises the steps of:
if said debtor is unable to pay the entire amount now due, determining how often said debtor is paid and dates of paydays;
determining a basic debit amount;
establishing a first debit date and debit schedule;
obtaining debtor's authorization to debit said asset account.

50. The method of claim 49, wherein said basic debit amount is approximately equal to half of one of a monthly payment and a monthly minimum payment if said payday is approximately bi-weekly.

51. The method of claim 49, wherein said basic debit amount is variable.

52. The method of claim 51, wherein said basic debit amount decreases as said account balance decreases.

53. The method of claim 49, further comprising the step of:
confirming said debit amount and said debit schedule with said debtor by letter.

54. The method of claim 49, wherein said step of implementing said series of payee-emitted checks comprises the steps of:
obtaining debit account information;
optionally, adding a fee to said basic debit amount; and
executing debits according to said terms of payment, negotiated payment amount and debit schedule.

55. The method of claim 54, wherein said step of obtaining debit account information comprises one of the steps of:
retrieving and confirming an account number and a routing number for an asset account from which a payment to said delinquent account was most recently made; and
obtaining an account number and a routing number from said debtor for an asset account to be debited.

56. The method of claim 54, wherein said step of executing debits comprises one or more of the steps of:
generating a check by said payee;
depositing said check to said payee's asset account;
presenting said check to said debtor's financial institution by said payee's financial institution for payment.

57. The method of claim 54, further comprising the step of:
when a debit has been dishonored a first or subsequent time, re-entering said debit after a pre-determined interval.

58. The method of claim 54, further comprising the step of:
when a debit has been dishonored one or more times, contacting said debtor.

59. The method of claim 54, further comprising the step of:
crediting said delinquent account.

60. The method of claim 45, further comprising the step of re-aging said delinquent account.

61. The method of claim 60, wherein said step of re-aging said delinquent account comprises one of the steps of:
bringing said delinquent account current; and
keeping said delinquent account delinquent by at least one payment cycle.

62. The method of claim 60, further comprising the step of:
where said delinquent account is a revolving account, after re-aging, re-opening said account if it has been closed.

63. A computer program product for collecting periodic payments on a consumer financial obligation, wherein payments are automatically debited to a customer's asset account through a series of payee-emitted checks on a payday-to-payday basis, said computer program product comprising a computer usable storage medium having computer readable computer code means embodied in the medium, the computer code means comprising computer readable program code means for:
obtaining a promise of regular, payday-to-payday payments against said financial obligation in the course of one or more of an oral, an electronic, and a telephonic communication;
negotiating a payment amount and debit schedule for said payments; and
implementing said series of funds transfers;
wherein said consumer assents to said terms of payment, said payment amount, said payment schedule and authorizes said implementation.

64. The computer program product of claim 63, wherein said communication is at least partially automated.

65. The computer program product of claim 63, wherein said consumer financial obligation comprises a delinquent account, wherein said payments are for amounts overdue and subsequently due on said delinquent account, and wherein said customer comprises a delinquent debtor.

66. The computer program product of claim 65, wherein said asset account comprises any type of account against which payee-emitted checks may be drawn

67. The computer program product of claim 65, wherein said payday-to-payday payments are any of monthly, bi-weekly, semi-monthly and weekly.

68. The computer program product of claim 65, wherein said computer readable program code means for negotiating a payment amount and a debit schedule comprises computer readable program code means for:
establishing contact with said debtor by telephone, and
attempting to secure payment of the entire amount due.

69. The computer program product of claim 68, wherein said computer readable program code means for negotiating a payment amount and a debit schedule further comprises computer readable program code means for:
if said debtor is unable to pay the full amount now due:
determining how often said debtor is paid and dates of paydays;
determining a basic debit amount;
establishing a first debit date and debit schedule; and
obtaining debtor's authorization to debit said asset account.

70. The computer program product of claim 69, wherein said basic debit amount is approximately equal to half of one of a monthly payment and a monthly minimum payment.

71. The computer program product of claim 69, wherein said basic debit amount is variable.

72. The computer program product of claim 71, wherein said basic debit amount decreases as said account balance decreases.

73. The computer program product of claim 69, wherein said computer readable code means further comprises:
computer readable program code means for confirming said debit amount and said debit schedule with said debtor by letter.

74. The computer program product of claim 69, wherein said computer readable program code means for implementing said series of electronic funds transfers comprises computer readable program code means for:
obtaining debit account information;
optionally, adding a fee to said basic debit amount; and
executing debits according to said terms of payment, negotiated payment amount and debit schedule.

75. The computer program product of claim 74, wherein said computer readable program code means for obtaining debit account information comprises computer readable program code means for one of:
retrieving and confirming an account number and a routing number for an asset account from which a payment to said overdue account was most recently made; and
obtaining an account number and a routing number from said debtor for an asset account to be debited.

76. The computer program product of claim 74, wherein said computer readable program code means for obtaining debit account information comprises computer readable program code means for one or more of:
generating a check by said payee;
depositing said check to said payee's asset account; and
presenting said check to said debtor's financial institution by said payee's financial institution for payment.

77. The computer program product of claim 74, further comprising computer readable program code means for:
when a debit has been dishonored, re-entering said debit after a predetermined interval.

78. The computer program product of claim 74, further comprising computer readable program code means for:
when a debit has been dishonored one or more times, contacting said debtor.

79. The computer program product of claim 74, further comprising computer readable program code means for crediting said account.

80. The computer program product of claim 65, further comprising computer readable program code means for re-aging said account.

81. The computer program product of claim 80, wherein said computer readable program code means for re-aging said account comprises computer readable program code means for one of:
bringing said account current; and
keeping said account delinquent by at least one payment cycle.

82. The computer program product of claim 80, further comprising computer readable program code means for:
where said account is a revolving account, after re-aging, re-opening said account if it has been closed.
